(19) United States
(12) Patent Application Publication
(10) Pub. No.: US 2007/0051103 A1
(43) Pub. Date: Mar. 8, 2007

(54) SUPER EFFICIENT ENGINE

(76) Inventor: Moshe Bar-Hai, Golan Hights (IL)

Correspondence Address: Mr.Moshe Bar-Hai, Avney Aitan, Golan Hights, 12925, IL

(21) Appl. No.: 11/162,386

(22) Filed: Sep. 8, 2005

(51) Int. Cl. F01B 29/10; F02G 1/04

(52) U.S. Cl. 60/517; 60/522

(57) ABSTRACT

An engine that increases efficiency by recycling unused heat rather than releasing it into the environment FIG. 4, FIG. 3. This invention consists of a Heat Engine (14), a Cooling Machine (19), a High Temperature Tank (13), and a Low Temperature Tank (16). The Heat Engine is responsible for producing work for the user and for powering the Cooling Machine. The Cooling Machine is responsible for creating a heat flow from the Low Temperature Tank to the High Temperature Tank. The High Temperature Tank is in effect a hot reservoir and the Low Temperature Tank is in effect a cold reservoir and they are responsible for powering the Heat Engine and storing the recycled heat. In this mechanism heat (from an external fuel source) can be applied to the High Temperature Tank or directly to the Heat Engine. This mechanism enables a complete conversion of heat to work (disregarding friction etc.)

### DESCRIPTION

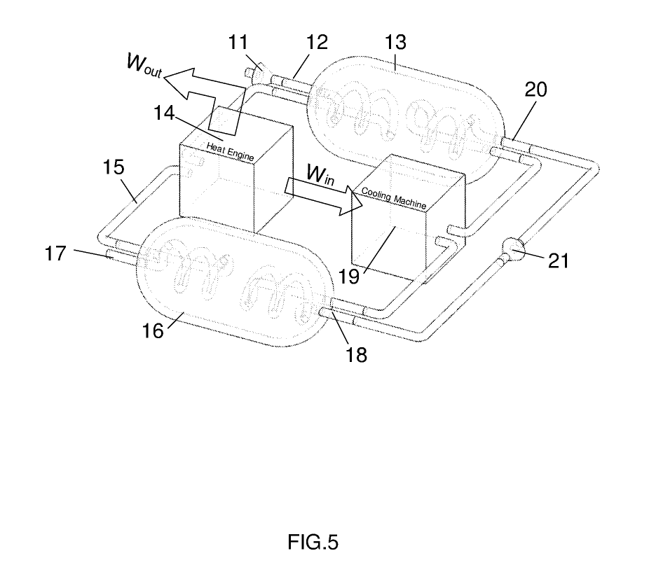

Operation FIG. 5 components 11 through 21.

Air is sucked into the one way valve (11), and then passes through the pipes (12) into the High Temperature Tank (13). The air absorbs heat from the High Temperature Tank and continues to the Heat Engine (14). The air in the Heat Engine is mixed with fuel (where Q=fuel energy) and is combusted to produce User work (Wₒᵤₜ and internal work (Wᵢₙ). The internal work is used for operating the Cooling Machine (19). After the air+fuel have combusted, the burned air+fuel continue through pipes (15) to the Low Temperature Tank (16). In the Low Temperature Tank heat is released from the burned air+fuel into the Low Temperature Tank. The burned air+fuel then continue out to the environment through the pipes (117).

The Cooling Machine (19) is basically a compressor that creates low pressure in pipes (18) (thus also creating a low temperature in pipes (18)) and a high pressure in pipes (20) (thus also creating a high temperature in pipes (20)), while the Pressure Valve (21) maintains the pressure difference.

A coolant is recycled through the pipes (18) and (20) and thereby extracts heat from the Low Temperature Tank (16) and transfers heat into the High Temperature Tank (13).

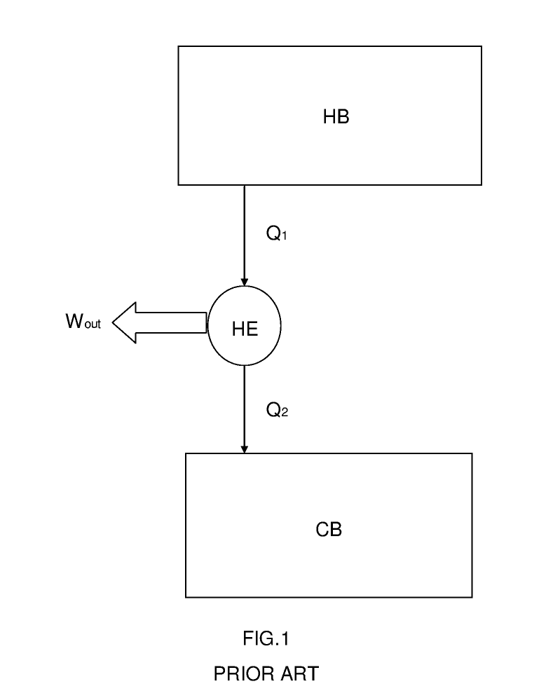

FIG. 1 shows the schematic of a Heat Engine.

Efficiency of Heat Engines is measured by the equation:
Efficiency=(Q₁−Q₂)/Q₁=Wₒᵤₜ/Q₁

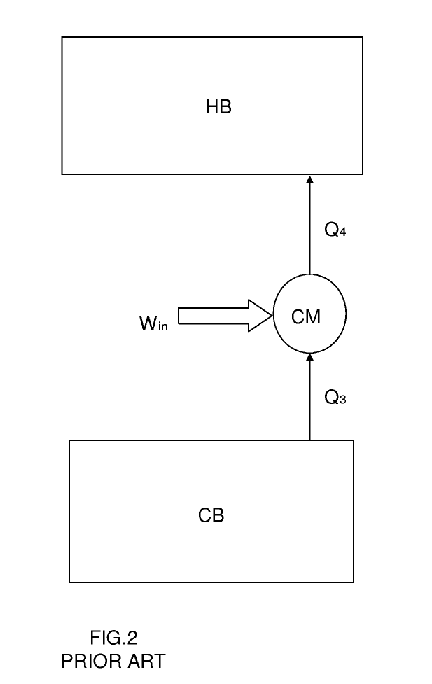

FIG. 2 shows the schematic of a Cooling Machine.

The Coefficient Of Operation (COP) of Cooling Machines is determined by:
COP=Q₃/(Q₄−Q₃)=Q₃/Wᵢₙ

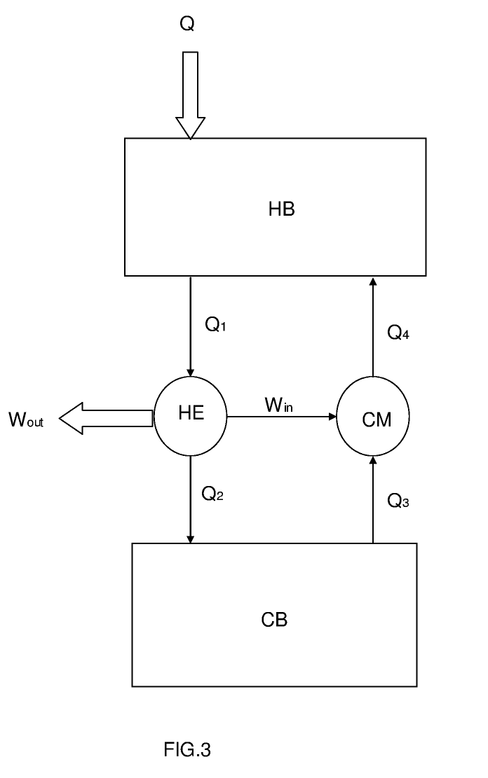

FIG. 3 shows the schematic of a SEE (Super Efficient Engine).

As shown the SEE is comprised of a Heat Engine and Cooling Machine.

Part of the work produced by the Heat Engine (Wᵢₙ) is applied to the Cooling Machine creating a heat cycle between the Hot Body and the Cold Body.

The outside source of heat (Q) is applied to the Hot Body.

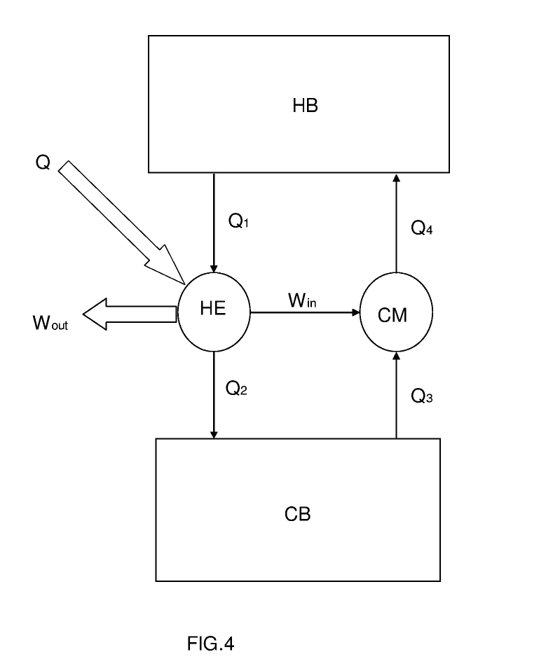

FIG. 4 shows the schematic of a SEE in which the outside source of heat is applied directly to the Heat Engine.

FIG. 5 shows a practical example of the schematic SEE depicted in FIG. 4

Definition List 1

| Term | Definition |
|---|---|
| Wₒᵤₜ | Work exiting the mechanism, that can be utilized for User |
| | consumption |
| Wᵢₙ | Work that is internal for operation of the Cooling Machine |
| Q | Heat applied from an outside source (like fuel) |
| Q₁ | Heat flow from the HB (Hot Body) to HE (Heat Engine) |
| Q₂ | Heat flow from the HE (Heat Engine) to CB (Cold Body) |
| Q₃ | Heat flow from the CB (Cold Body) to CM (Cooling Machine) |
| Q₄ | Heat flow from the CM (Cooling Machine) to HB (Hot Body) |
| HB | Hot Body - at a higher temperature than the Cold Body and |
| | the environment |
| CB | Cold Body - at a lower temperature than the Hot Body and |
| | the environment |
| HE | Heat Engine, utilizes the natural flow of heat to produce work |
| | (like a car engine) |
| CM | Cooling Machine, work is utilized to reverse the natural flow of |
| | heat (like a refrigerator), (also known as heat pump) |
| Q_{HB} | Heat change in Hot Body |
| Q_{CB} | Heat change in Cold Body |

Definition List 2

| Term | Definition |
|---|---|
| 11 | One Way Valve |
| 12 | Pipe |
| 13 | High Temperature Tank |
| 14 | Heat Engine |
| 15 | Pipe |
| 16 | Low Temperature Tank |
| 17 | Pipe |
| 18 | Pipe |
| 19 | Cooling Machine |
| 20 | Pipe |
| 21 | Pressure Valve |

The above examples portray the working principles and materialization of my invention. They should not be understood as limitation of scope, for the scope of the invention should be determined by the appended claims and their legal equivalent rather than by the examples given.

Mathematical Calculations and Contradiction of the Second Law of Thermodynamics

The second law of thermodynamics states that there is no such mechanism that can completely convert heat to work, therefore my invention cannot work.

I believe this to be inaccurate for two reasons:

A) The attempts to increase efficiency of heat engines by utilizing the unused exhaust heat are usually made by using the exhaust heat from one large heat engine to power a smaller heat engine. For example the use of dual turbine power stations where one turbine works at a high temperature and pressure and the other turbine works on the exhaust gas of the first and at a lower pressure and temperature. But since all heat engines need a flow of heat from a high source to a low source, trying to achieve theoretical complete efficiency means you will need an infinite number of heat engines each working on the exhaust heat of the former until the last heat engine depletes no heat. Obviously this is impossible (hence the second law of thermodynamics). Then why do I presume to have an invention that can achieve complete theoretical efficiency?

Because my invention does not comprise solely a heat engine but a heat engine and a cooling machine. It is true that the heat engine needs a flow of heat from a hot source to a cold source, but the cooling machine creates the opposite heat flow namely from a cold source to a hot source, therefore used together they can create a heat cycle that enables a theoretical complete conversion of heat to work (disregarding loss of efficiency due to friction etc.).

On Heat Engine Evolution:

One of the first heat engines was a locomotive that burned wood to heat water to create steam, in order to power a turbine, which in turn powered the “wheels”. The problem was that after a short while all the water evaporated into the environment, so in order to work the locomotive had to carry a large unpractical amount of water. Than the idea of recycling the water was invented by cooling and reheating the water the in a closed system. The next stage is to recycle heat and thereby lower the cost of converting heat to work, which I claim my invention will do.

B) The second law of thermodynamics is an empirical law, meaning it was concluded through trial and error rather than having been proved mathematically, so isn't it possible that it is right only for specific conditions? For instance I believe it applies only to heat engines and not to every possible mechanism for converting heat to work. Therefore I don't believe it applies to my invention, and in the next page I will give a mathematical explanation of why my invention can completely convert heat to work.

Mathematical Calculations

Calculating for FIG. 4

Applying the law of energy preservation on the different energy junctions we obtain the following four equations:
Q+Q₁=Q₂+Wᵢₙ+Wₒᵤₜ (for Heat Engine) 1
Q_{CB}=Q₂−Q₃ (for Cold Body) 2
Wᵢₙ+Q₃=Q₄ (for Cooling Machine) 3
Q_{HB}=Q₄−Q₁ (for Hot Body) 4
The above formulas consist of 9 variables and 4 equations, when the mechanism reaches equilibrium the temperatures of the hot body and cold body will stay fixed, this means that:
Q_{HB}=Q_{CB}=0
Now we can write equations 2, 4 thus:
Q₂=Q₃ 2
Q₄=Q₁ 4
After integrating equations 2, 4 into 1, 3:
Q+Q₄=Q₂+Wᵢₙ+Wₒᵤₜ 1
Wᵢₙ+Q₂=Q₄ 3
Integrating equation 3 into 1:
Q+Wᵢₙ+Q₂=Q₂+Wᵢₙ+Wₒᵤₜ 1
Finally after simplifying:
Q=Wₒᵤₜ
Or in words: “the amount of heat invested equals the amount of work received”

1. (canceled)

2. Method for converting heat to work comprising a Heat Engine, a Heat Pump, a High Temperature Body, a Low Temperature Body, and an external heat source wherein said Heat Engine receives heat from said High Temperature Body and the heat source, and discharges work to said Heat Pump and to the user, and releases heat to said Low Temperature Body, wherein said Heat Pump causes a heat flow from said Low Temperature Body to said High Temperature Body.

3. The method of claim 2 wherein the heat source can apply heat to said High Temperature Body or directly to said Heat Engine.

4. The method of claim 2 wherein heat is recycled from said Heat Engine to said Low Temperature Body to said Heat Pump to said High Temperature Body back to said Heat Engine.

5. The method of claim 2 wherein said Heat Engine Powers said Heat Pump.

6. The method of claim 2 wherein said method of converting heat to work is of 100 percent theoretical efficiency.
